(19) United States
(12) Patent Application Publication
(10) Pub. No.: US 2006/0285324 A1
(43) Pub. Date: Dec. 21, 2006

(54) Color-mixing lighting system

(75) Inventors: Johannes Petrus Maria Ansems, Eindhoven (NL); Christoph Gerard Hoelen, Eindhoven (NL); Thomas Juestel, Witten (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/569,020

(22) PCT Filed: Aug. 9, 2004
(86) PCT No.: PCT/IB04/51431

§ 371 Date: Feb. 23, 2006

(30) Foreign Application Priority Data
Aug. 29, 2003 (EP) 03103253.5

(51) Int. Cl. F21V 9/00

(52) U.S. Cl. 362/231

(57) ABSTRACT

A color-mixing lighting system has a light-emitting diode (6, 7) emitting first visible light having a first peak wave-length in a first spectral range and has a fluorescent material (8) converting a portion of the first visible light into second visible light having a second peak wavelength in a second spectral range. The second visible light has a full width at half maximum (FWHM) of at least 50 nm. Preferably, the second visible light is red light, the second peak wavelength being in the range from 590 to 630 ran, preferably, in the range from 600 to 615 nm. Preferably, the lighting system comprises a further light-emitting diode (7) for emitting third visible light having a third peak wavelength in a third spectral range. The color-mixing lighting system according to the invention generates white light with a high color-rendering index and allows certain variations in the wavelength of the primaries.

The invention relates to a color-mixing lighting system comprising at least one light-emitting diode and a at least one fluorescent material.

Lighting systems based on light-emitting diodes (LEDs) in combination with fluorescent materials are used as a source of white light for general lighting applications. In addition, such lighting systems are employed for illuminating display devices, for instance, liquid crystal display (LCD) devices or light tiles.

A color-mixing lighting system of the type mentioned in the opening paragraph is known from U.S. Pat. No. 6,234,648 (PHN 17 100). The known color-mixing lighting system comprises at least two light-emitting diodes each emitting, in operation, visible light in a pre-selected wavelength range. A converter converts part of the visible light emitted by one of the LEDs into visible light in a further wavelength range so as to optimize the color rendition of the lighting system. Preferably, the diodes include a blue light-emitting diode and a red light-emitting diode and the converter includes a luminescent material for converting a portion of the light emitted by the blue light-emitting diode into green light.

It is a drawback of the known color-mixing lighting system that a combination of LEDs and luminescent material does not always lead to the desired color-rendering index (CRI).

The invention has for its object to eliminate the above disadvantage wholly or partly. In particular, it is an object of the invention to provide a color-mixing lighting system generating white light with a relatively high color-rendering index. According to the invention, a color-mixing lighting system of the kind mentioned in the opening paragraph for this purpose comprises:

a light-emitting diode emitting first visible light having a first peak wavelength in a first spectral range,

a fluorescent material converting a portion of the first visible light into second visible light having a second peak wavelength in a second spectral range,

the second visible light having a full width at half maximum (FWHM) of at least 50 nm.

In the description and claims of the present invention, the term “full width at half maximum” is used to describe the width of the emission spectrum of the light source. The emission profile of a light source as a function of the wavelength resembles that of a Gaussian curve. In order to compare different profiles, normally the width across the profile when it drops to half of its peak, or maximum, value is employed. This “width” is addressed as the so-called FWHM.

It is known to combine blue, green and red light-emitting diodes (LEDs) in a color mixing system to make white light for general lighting applications. The correlated color temperature (CCT) can be set by properly tuning the power ratio of the individual LEDs. If the spectral emission band wavelength of the three LEDs is in the range 430-470 nm, 520-560 nm, and 590-630 nm, a color-rendering index (CRI) of about 80-85 is possible. In addition, it is known that the emission spectrum of a LED typically exhibits a single, relatively narrow peak at a wavelength (“peak wavelength”) determined by the structure of the light-emitting diode and the composition of the materials from which the LED is constructed. This implies that combining a blue, green and red LED to form a light source of white light puts limits to the achievable CRI. In addition, the obtainable color-rendering index is very sensitive to small wavelength variations of the LEDs.

According to the invention, a LED emitting first visible light having a first peak wavelength in a first spectral range (for example a LED emitting blue light) is combined with a fluorescent material converting a portion of the first visible light, or any other suitable pump wavelength, into second visible light having a second peak wavelength in a second spectral range (for example part of the blue light is converted into red light). Because the second visible light has a full width at half maximum (FWHM) of at least 50 nm, which is considerably larger than that of a corresponding LED of a emitting corresponding of at least 50 nm (a typical FWHM of a red LED is approximately 20 nm), a light source can be designed and manufactured with a high color-rendering index which is relatively insensitive to significant wavelength variations (e.g. up to more thant 50% of the typical FWHM) of the individual LEDs.

In particular red LEDs are sensitive to variations in the peak wavelength and in flux induced by temperature variations and are less stable than blue to green InGaN LEDs. Additionally, the CRI is particularly sensitive to small variations in the peak wavelength of the narrow banded red LEDs. To this end, a preferred embodiment of the color-mixing lighting system according to the invention is characterized in that the second visible light is red light, the second peak wavelength being being in the range from 590 to 630 nm. Preferably, the second peak wavelength being in the range from 600 to 615 nm. The red light is generated by a luminescent material having a FWHM of at least 50 nm.

Avoiding the use of a red LED in the color-mixing lighting system according to the invention has several advantages. Normally, blue and green LEDs (for example InGaN flip chips) are individually mounted on a sub-mount. Wire bonding of this sub-mount for electrical connection is necessary. The wire bonds are vulnerable and limit the options for encapsulating the LED chips. However, in case of a single sub-mount for multiple chips, with a proper conducting structure, practically all bond wires can be omitted for the connection of these blue and green LED chips. However, red emitting LEDs (for example, AlInGaP chips) are normally not available in a flip chip version implying that a bond wire to these red LEDs is still necessary.

In addition, the known red LEDs exhibit a good luminous efficacy at room temperature. However, this efficacy drops to practically half of that value at the normal working temperature (of the junction) of about 100° C. Up to these temperatures, the blue and green LEDs only show a relatively small decrease in efficacy. If even higher junction temperatures are desirable, this would considerably reduce the efficacy of the red LED to relatively low levels.

A further disadvantage of employing a red LED is that the peak wavelength of the red LED (for instance an AlInGaP chip) exhibits a relatively large shift with the expected temperature rise induced by operation at full power. This implies that by dimming the light source the color properties of the red LED will change considerably. Although upon dimming, the color point can be kept relatively constant by actively monitoring the color point and by compensating any color changes by adjusting drive currents, it is, however, not possible to compensate for changes in the color-rendering index.

By avoiding the use of a red LED, the problems mentioned hereinabove can be avoided wholly or partly. In addition, by applying red light generated by a luminescent material having a FWHM of at least 50 nm, a light source can be designed and manufactured with a high color-rendering index which is relatively insensitive to wavelength variations of the individual LEDs.

The wavelength range for the peak wavelength of the red light in the range from 590 to 630 nm, or, preferably in the range from 600 to 615 nm, is a purposive selection from the range of red-emitting luminescent materials. The inventors have found out that by narrowing the range for selecting the red peak wavelength in combination with blue and green LEDs (for example InGaN flip chips), white light (in the range from 2700K to 5000K) can be produced with a CRI of higher than 90, while allowing certain variations in the emission wavelengths of the blue and green LEDs.

From calculations and experiments employing blue and green LEDs in combination with a red-luminescent material, the following can be concluded (see for details the detailed description of the preferred embodiments of the invention). The combination of a red-luminescent material with a blue and a green LED in the color-mixing lighting system according to the invention is very robust with respect to peak wavelength variations in the blue and the green LED, and results in very high CRI values. In particular, for realizing a CRI≧80 in the entire T_{c} range of 2700-5000 K variations in the peak wavelengths of the blue and green LED of approximately 15 nm are allowed. In addition, for realizing a CRI≧90 in the entire T_{c} range of 2700-5000 K variations in the peak wavelengths of the blue and green LED of approximately 7 nm are allowed. It is remarked that, in the event the blue and green LED do not vary in peak wavelength independently or do not vary in the same wavelength interval (e.g. selecting green in a small wavelength range and allowing blue to vary in a (much) larger wavelength range), the relevant wavelength ranges for the blue and the green LED can be much larger than indicated. The same applies true in case the system aims at a specific color temperature or a smaller color temperature range.

A preferred embodiment of the color-mixing lighting system according to the invention is characterized in that the first visible light-emitting diode emits blue light, the first peak wavelength being in the range from 450 to 470 nm and the full-width at half maximum (FWHM) being in the range from 20 to 25 nm. A suitable blue LED is an InGaN flip chip.

In order to make white light for illumination based on three spectral bands normally a tri-color color-mixing lighting system is used. Such a color-mixing lighting system comprises a blue, green and red light source. The third light source can either be a further LED a further fluorescent material. Of course also a four-color color-mixing lighting system can be manufactured by employing an appropriate mix of blue/cyan, green, yellow/amber and red light sources. Such colors can either be achieved by suitable combining LEDs with luminescent materials.

To this end, a preferred embodiment of the color-mixing lighting system according to the invention is characterized in that the lighting system comprises a further light-emitting diode for emitting third visible light having a third peak wavelength in a third spectral range. Preferably, the further light-emitting diode emits green light, the third peak wavelength being in the range from 510 to 550 nm and the full width at half maximum (FWHM being in the range from 25 to 45 nm.

Alternatively, a preferred embodiment of the color-mixing lighting system according to the invention is characterized in that the lighting system comprises a further fluorescent material converting a portion of the first visible light into third visible light having a third peak wavelength in a third spectral range with the third peak wavelength in the range from 510 to 550 nm and a FWHM of at least 40 nm.

These and other aspects of the invention are apparent from and will be elucidated with reference to the embodiments described hereinafter.

In the drawings:

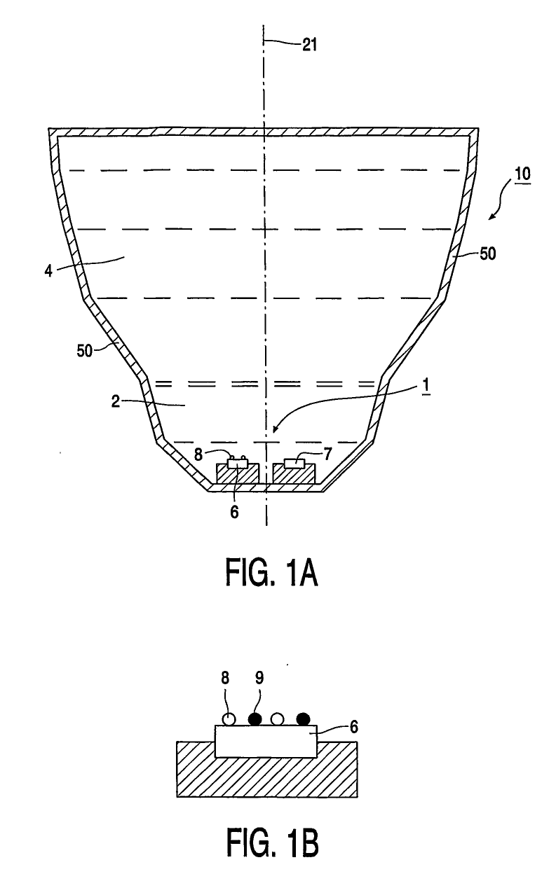

FIG. 1A is a cross-sectional view of a luminaire comprising a color-mixing lighting system according to the invention;

FIG. 1B is a cross-sectional view of an alternative embodiment of the color-mixing lighting system according to the invention;

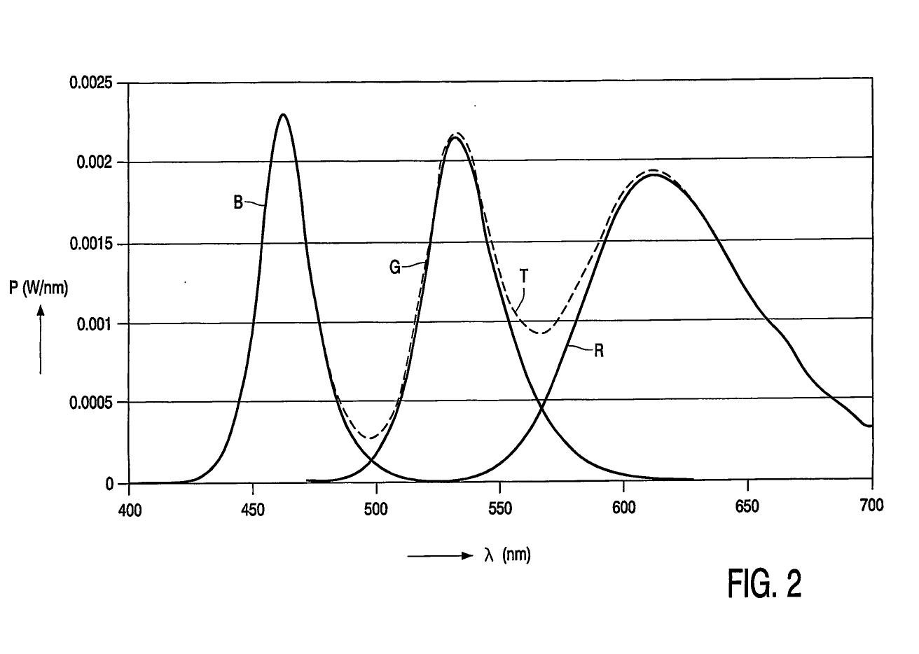

FIG. 2 shows the spectral composition of a color-mixing lighting system according to an embodiment of the invention comprising a blue and a green LED in combinations with a red-emitting luminescent material;

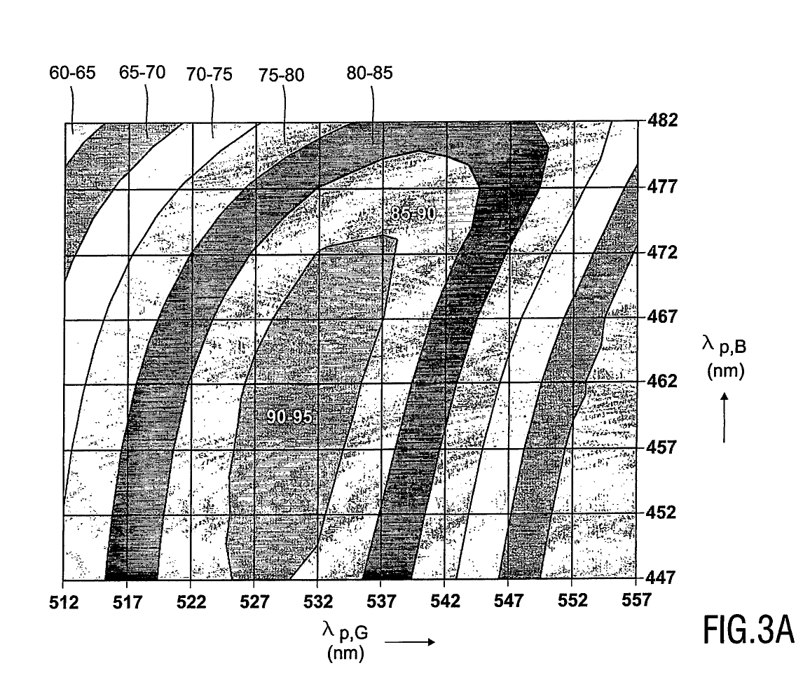

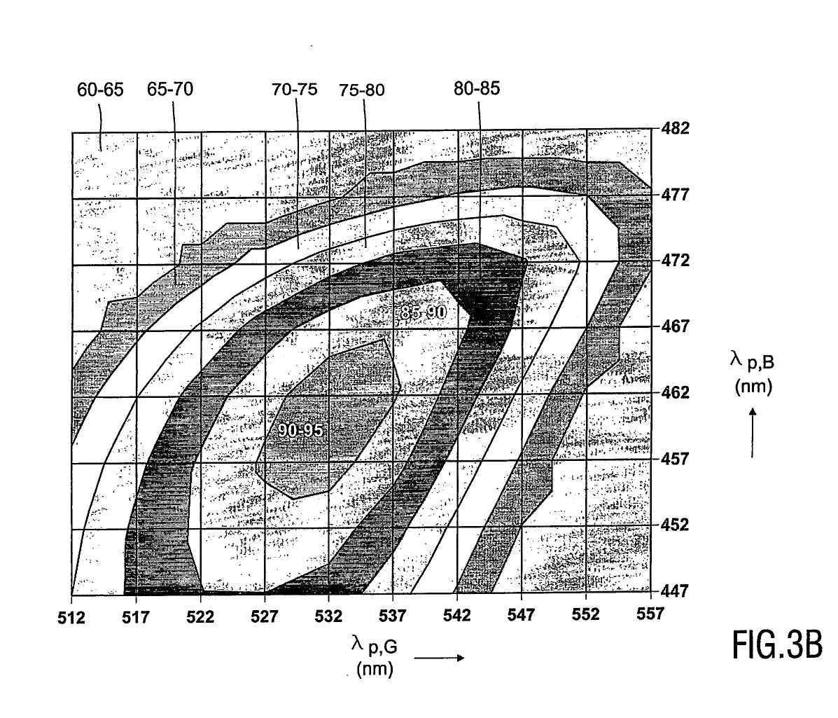

FIG. 3A shows the color-rendering index for a color-mixing lighting system according to an embodiment of the invention comprising a blue and a green LED in combination with a red-emitting luminescent material as a function of the blue and green LED peak wavelength for a color temperature of 2700 K, and

FIG. 3B shows the color-rendering index for a color-mixing lighting system according to an embodiment of the invention comprising a blue and a green LED in combination with a red-emitting luminescent material as a function of the blue and green LED peak wavelength for a color temperature of 5000 K.

The Figures are purely diagrammatic and not drawn to scale. Notably, some dimensions are shown in a strongly exaggerated form for the sake of clarity. Similar components in the Figures are denoted as much as possible by the same reference numerals.

FIG. 1A schematically shows a cross-sectional view of a luminaire comprising a color-mixing lighting system in accordance with the invention. As illustrated, the luminaire comprises a color-mixing lighting system 1 and a reflector 10. The color-mixing lighting system 1 comprises a plurality of blue and green LED chips 6, 7 and a red-emitting luminescent material 8 provided partly on top of the blue LED chip 6, or be provided completely on top of a suitable pump LED (emitting e.g. near-UV, blue, cyan or cyan-green). The luminescent material 8 may be applied as dots on the blue LED chip 6; in an alternative embodiment the luminescent material is applied as a layer with a pre-determined thickness on the LED chip or on part of the chip. According to the invention, the red-emitting luminescent material 8 has a full width at half maximum (FWHM) of at least 50 nm. Preferably, the peak wavelength of the red-emitting luminescent material is in the range from 600 to 615 nm.

Preferably, the fluorescent material 8 converting blue light into red light is selected from the group formed by SrS:Eu, Sr₂Si₅N₈:Eu, CaS:Eu, Ca₂Si₅N₈:Eu, (Sr₁₋ₓCaₓ)S:Eu and (Sr₁₋ₓCaₓ)₂Si₅N₈:Eu and (x=0−1). A very suitable luminescent material is Sr₂Si₅N₈:Eu which luminescent material exhibits a relatively high stability. In addition, Sr₂Si₅N₈:Eu is a luminescent material which avoids the use of sulfides. SrS:Eu has a peak wavelength of approximately 610 nm, Sr₂Si₅N₈:Eu has a peak wavelength of approximately 620 nm, CaS:Eu has a peak wavelength of approximately 655 nm, whereas Ca₂Si₅N₈:Eu has a peak wavelength of approximately 610 nm.

Due to the much broader spectral range of the red-luminescent material 8 as compared to the red LED (FWHM of about 70 nm compared to 20 nm, respectively) a color-mixing lighting system can be realized with a CRI better than 90 with only three colors (also see FIG. 3).

At the normal working temperature of the color-mixing lighting system no significant luminescence quenching of the above mentioned phosphors is observed. In addition, the peak wavelength of the luminescent material 8 is stable for temperatures up to 200° C. (in strong contrast to the red AlInGaP LED emission). The temperature dependence of the red flux of the luminescent material 8 is, in good approximation, the same as for the InGaN colors (blue to green). In addition, binning of the red LEDs is no longer necessary thanks to the stable emission of the red-luminescent material 8.

The reflector 10 is provided with at least a portion of its circumferential wall having a polygonal cross-section and at least a portion of the circumferential body comprising facets 50. The reflector 10 collimates light to the desired angular distribution and mixes the light from the color-mixing lighting system 1. A first section 2 of the reflector may comprise a filler or an encapsulating material for the blue and green LED chips 6, 7 and a red-emitting luminescent material 8. In an alternative embodiment, section 2 forms the color-mixing lighting system. A top section 4 of the reflector 10 may be in air, if desired, and is in fact preferred to be in air due to favorable cost and weight considerations. Preferably, the reflector 10 is a hollow tube-like structure with n-fold symmetry (typically n=6 or 8, but may be any integer) about an optical axis 21. The cross-section of the top section 4 in any plane perpendicular to the optical axis 21 is a regular polygon, for example, a hexagon or an octagon, centered about the optical axis 21. The reflector 10 may include a (transparent) cover plate 16 for mechanically protection of the main reflector. The cover plate 16 may be formed of materials such as plastic and glass, for example and may be a flat, smooth plate of clear transparency, or it may have any desired amount of diffusion and may be ground glass, prismatic glass, corrugated glass, etc., and/or it may have steering or refraction properties or combinations of these properties. The specific properties of the cover plate 16 will affect the appearance of the color-mixing lighting system 1 and to a certain extent will affect the overall light output distribution. The cover plate 16 is, however, not essential to the principle of operation, but rather provides flexibility and variation of the design of the reflector 10.

The luminaire as shown in FIG. 1A accepts a full 2×90° emission of the array of the LED chips 6, 7 and the red-emitting luminescent material 8 without any provision for “primary optics” close to the LEDs 6,7 and the luminescent material 8.

FIG. 1B schematically shows a cross-sectional view of an alternative embodiment of the color-mixing lighting system according to the invention. As illustrated, the color-mixing lighting system 1 comprises a plurality of blue LED chips 6 and a red-emitting luminescent material 8 and a green-emitting luminescent material 9, both luminescent material 8, 9 being provided partly on top of the blue LED chip 6.

Preferably, the fluorescent material 9 converting blue light into green light is selected from the group formed by (Ba_{1×x}Srₓ)SiO₄:Eu (x=0-1, preferably x=0.5), SrGa₂S₄:Eu, Lu₃Al₅O₁₂:Ce and SrSi₂N₂O₂:Eu. In terms of stability, Lu₃Al₅O₁₂:Ce and SrSi₂N₂O₂:Eu are very suitable luminescent material. In addition, these latter luminescent materials avoid the use of sulfides. (Ba_{0.5}Sr_{0.5})₂SiO₄:Eu has a peak wavelength of approximately 523 nm, SrGa₂S₄:Eu has a peak wavelength of approximately 535 nm, Lu₃Al₅O₁₂:Ce has peak wavelengths at approximately 515 nm and 545 nm, whereas SrSi₂N₂O₂:Eu has a peak wavelength of approximately 541 nm.

If a yellow/amber emitting luminescent material is employed in the color-mixing lighting system according to the invention, a very suitable luminescent material is (Y₁₋ₓGdₓ)₃(Al_{1-y}Ga_{y})₅O₁₂:Ce with a peak wavelength in the range from 560-590 nm depending on the values of x and y in the chemical formula. Preferably, x and y are in the range 0.0 to 0.5.

Due to the much broader spectral range of the green luminescent material as compared to the green LED (FWHM of about 70 nm compared to 40 nm) a color-mixing lighting system can be realized with a relatively high CRI can be realized.

Preferred LED-based light sources comprise:
1) A 3-color system, consisting of a composition of blue emitting InGaN LED chips, green emitting InGaN LED chips or, preferably, blue emitting chips pumping a green emitting luminescent material (phosphor), and InGaN chips pumping a red emitting phosphor. This luminescent material is preferably pumped by a cyan-green emitting LED chip to minimize the Stokes shift energy loss caused by the conversion process.
2) A 4-color system, consisting of a composition of blue emitting LED chips, and three different luminescent materials converted colors pumped by blue or longer wavelength emitting LED chips such that the efficacy is optimized (Stokes shift minimized).
3) A single color-parameter system, consisting of blue or cyan emitting LED chips, blue chips pumping a cyan-emitting luminescent material with significant blue leakage, and LED chips pumping a mixture of luminescent materials, preferably green, yellow/amber and red emitting phosphors.

The preferred-luminescent materials (phosphors) are Eu²⁺and Ce³⁺doped materials made from alkaline earth oxide, sulfide, nitride, SiON, or SiAlON type host lattices, which show significant advantages over many commercial phosphors, e.g. strong absorption of blue light.

For selecting the wavelength range of the red-luminescent material, the following considerations may apply. For a color temperature of T_{c}=2700 K, the optimal (CRI≧92) peak wavelength λ_{p, red phosphor} of the red-luminescent material is, preferably, in the range from:
λ_{p, red phosphor}=610 -615 nm.
Similarly for T_{c}=5000 K:
λ_{p, red phosphor}=600 -605 nm.
For CRI≧90, the lower limit for the peak wavelength of the red-luminescent material is preferably 590 nm (at T_{c}=5000 K) and the upper limit is preferably, 630 nm (at T_{c}=2700 K).

In addition, for CRI≧90 while allowing a wavelength variation of at least 5 nm in both the blue LED and the green LED, the lower limit (at T_{c}=5000 K) is:
λ_{p, red phosphor}=595 nm,
while the upper limit (at T_{c}=2700 K) is:
λ_{p, red phosphor}=620 nm.

To be able to reach CRI≧90 for the whole T_{c} range from 2700 K to 5000 K, preferably,
λ_{p, red phosphor}=605 -615 nm.

For CRI≧80, while allowing wavelength variation of at least 15 nm of both the peak wavelength of the blue and green LED, the lower limit (at T_{c}=5000 K) is:
λ_{p, red phosphor}=590 nm,
while the upper limit (at T_{c}=2700 K) is:
λ_{p, red phosphor}=620 nm.
In order to be able to reach CRI≧80 for the whole T_{c} range from 2700 K to 5000 K the peak wavelength of the red-luminescent material is, preferably, in the range:
λ_{p, red phosphor}=590-630 nm.
From the above considerations, the following can be concluded:
1) Taking CRI≧80 as criterion, while allowing a relative large variation of 15 nm in the peak wavelength of both the blue and the green LED, the peak wavelength of the red-luminescent material is, preferably, in the range:
   λ_{p, red phosphor}=590-620 nm.
2) Taking CRI≧90 as criterion, while allowing a reasonable variation of about 7 nm in the peak wavelength of both the blue and the green LED (the relative large variation of 15 nm for both blue and green is not possible in this case), the peak wavelength of the red-luminescent material is, preferably, in the range:
   λ_{p, red phosphor}=600 -615 nm.
   A very favorable peak wavelength of the red-luminescent material (for the color temperature range from 2700 to 5000 K) is:
   λ_{p, red phosphor}=610 nm.

For selecting the wavelength range of the blue LED in view of the above considerations for the red-luminescent material, the following considerations may apply, assuming a peak wavelength for the red-luminescent material:
λ_{p, red phosphor}=610 nm.
For CRI≧90 and a green peak wavelength variation of at least 5 nm, the blue peak wavelength is, preferably, in the range from:
the lower limit is λ_{p, B}=448 nm (at T_{c}=2700 K),
the upper limit is λ_{p, B}=473 nm (at T_{c}=2700 K).
At higher T_{c}, the wavelength range is smaller.

To be able to obtain CRI>90 over the whole T_{c} range with a green peak wavelength variation of at least 5 nm, the blue peak wavelength is, preferably, in the range from:
λ_{p, B}=456-465 nm.
It is remarked that in this case G and B are not independent.

To be able to obtain CRI≧90 over the whole T_{c} range with an independent green peak wavelength variation of at least 5 nm, the blue peak wavelength is, preferably, in the range from:
λ_{p, B}=458-463 nm.
For CRI≧80 and a green peak wavelength variation of at least 15 nm, the blue peak wavelength is, preferably, in the range from:
the lower limit is λ_{p, B}=435 nm (at T_{c}=2700 K),
the upper limit is λ_{p, B}=480 nm (at T_{c}=2700 K).
At higher T_{c}, the wavelength range is smaller.
To be able to obtain CRI≧80 over the whole T_{c} range with a green peak wavelength variation of at least 5 nm, the blue peak wavelength is, preferably, in the range from:
λ_{p, B}=440-474 nm.
To be able to obtain CRI≧80 over the whole T_{c} range with a green peak wavelength variation of at least 15 nm, the blue peak wavelength is, preferably, in the range from:
λ_{p, B}=445-471 nm.
It is remarked in these cases that G and B are not independent.

To be able to obtain CRI≧80 over the whole T_{c} range with an independent green peak wavelength variation of at least 5 nm, the blue peak wavelength is, preferably, in the range from:
λ_{p, B}=445-470 nm.
To be able to obtain CRI≧80 over the whole T_{c} range with an independent green peak wavelength variation of at least 15 nm, the blue peak wavelength is, preferably, in the range from:
λ_{p, B}=452-467 nm

For selecting the wavelength range of the green LED in view of the above considerations for the red-luminescent material and the blue LED, the following considerations may apply, assuming a peak wavelength for the red-luminescent material:
λ_{p, red phosphor}=610 nm.
For CRI≧90 and a blue peak wavelength variation of at least 5 nm, the green peak wavelength is, preferably, in the range from:
the lower limit is λ_{p, G}=525 nm (at T_{c}=2700 K),
the upper limit is λ_{p, G}=537 nm (at T_{c}=2700 K).
At higher T_{c}, the wavelength range is smaller.

To be able to obtain CRI≧90 over the whole T_{c} range with a blue peak wavelength variation of at least 5 nm, the green peak wavelength is, preferably, in the range from:
λ_{p, G}=528-536 nm.
It is remarked in this case that G and B are not independent.

To be able to obtain CRI≧90 over the whole T_{c} range with an independent blue peak wavelength variation of at least 5 nm, the green peak wavelength is, preferably, in the range from:
λ_{p, G}=529-534 nm.

For CRI≧80 and a blue peak wavelength variation of at least 15 nm, the green peak wavelength is, preferably, in the range from:
the lower limit is λ_{p, G}=516 nm (at T_{c}=2700 K),
the upper limit is λ_{p, G}=545 nm (at T_{c}=2700 K).
At higher T_{c}, the wavelength range is smaller.
To be able to obtain CRI≧80 over the whole T_{c} range with a blue peak wavelength variation of at least 5 nm, the green peak wavelength is, preferably, in the range from:
λ_{p, G}=516-546 nm.
To be able to obtain CRI≧80 over the whole T_{c} range with a blue peak wavelength variation of at least 15 nm, the green peak wavelength is, preferably, in the range from:
λ_{p, G}=518-543 nm.
It is remarked in these cases that G and B are not independent.

To be able to obtain CRI≧80 over the whole T_{c} range with an independent blue peak wavelength variation of at least 5 nm, the green peak wavelength is, preferably, in the range from:
λ_{p, G}=520-542 nm.
To be able to obtain CRI≧80 over the whole T_{c} range with an independent blue peak wavelength variation of at least 15 nm, the green peak wavelength is, preferably, in the range from:
λ_{p, G}=524-539 nm.
From the above considerations about mixing colors it may be concluded, that for mixing red, green and blue it is advantageous to employ a red phosphor in combination with intrinsic green and blue LED emission. With a peak wavelength of the red-luminescent material of:
λ_{p, red phosphor}=610 nm,
the highest CRI values for the whole T_{c} range (2700-5000 K) are obtained with a peak wavelength of the blue LED of:
λ_{p, B}=460 nm,
in combination with a peak wavelength of the green LED of
λ_{p, G}=531 nm.

To cover the T_{c} range from 2700 K to 5000 K the optimal peak wavelengths or peak wavelength ranges (where all wavelength combinations are still valid to obtain the indicated CRI) are summarized in the Table I.

TABLE I
Preferred wavelength ranges for attaining a desired color-rendering index.

| CRI | ≧90 | ≧80 |
|---|---|---|
| red-luminescent | 610 nm | 610 nm |
| material | | |
| green LED | 529-534 nm | 524-539 nm |
| blue LED | 458-463 nm | 452-467 nm |

This result can be compared to known combinations of red, green and blue LEDs (for example employing AlInGaP LED chips). Best CRI results are obtained at peak wavelengths of about:
λ_{p, R}=615 nm,
λ_{p, G}=540 nm,
λ_{p, B}=462 nm.

It is noted that with this combination of three LEDs with ideal wavelengths it is not possible to obtain a CRI≧90. Taking into account wavelength variations, for CRI≧80, the result as given in Table II is obtained. Note the relatively small allowed variations for the peak wavelengths (approximately 6 nm).

TABLE II
Preferred wavelength ranges for attaining a desired color-rendering index.

| CRI | ≧90 | ≧80 |
|---|---|---|
| red LED | n.a. | 613-618 nm |
| green LED | n.a. | 537-543 nm |
| blue LED | n.a. | 458-465 nm |

FIG. 2 shows the spectral composition of a color-mixing lighting system according to an embodiment of the invention comprising a blue and a green LED 6, 7 in combinations with a red-emitting luminescent material 8. The output power P (expressed in Watt/mm) of the elements of the color-mixing lighting system is depicted as a function of the wavelength λ (expressed in nm). Curve referenced “B” shows the emission spectrum of the blue LED 6, curve referenced “G” shows the emission spectrum of the green LED 7, Curve referenced “R” shows the emission spectrum of the red-luminescent material 8. The total spectrum is depicted by the curve referenced “T”. The color-mixing lighting system as shown in FIG. 2 is capable of emitting 100 lm at a correlated color temperature (CCT) of 4000 K with a color-rendering index (CRI) of 94. Because at junction temperatures of 25° C. and 120° C. the spectrum of the red-emitting luminescent material 8 is the same, the CRI remains at the relatively high level of 94.

FIG. 3A shows the color-rendering index for a color-mixing lighting system according to an embodiment of the invention comprising a blue and a green LED 6, 7 in combination with a red-emitting luminescent material 8 as a function of the blue and green LED peak wavelength for a color temperature of 2700 K.

In the example of FIG. 3A, a red-emitting luminescent material 8 is employed with a wavelength peak of 610 nm and with a FWHM of 83 nm. Along the y-axis of FIG. 3A, the peak wavelength λ_{p, B} (expressed in nm) of the blue LED 6 with a typical FWHM of 23 nm is depicted with the peak wavelengths varying between 447 nm and 482 nm. Along the x-axis of FIG. 3A the peak wavelength λ_{p, G} (expressed in nm) of the green LED 7 with a typical FWHM of 35 nm is depicted with the peak wavelengths varying between 512 nm and 557 nm. The different areas depicted in FIG. 3A show the areas with a certain value of the color-rendering index (CRI). In particular, the central area in FIG. 3A represents the area for which the CRI is in the range between 90 and 95. The first area around the central area in FIG. 3A represents the area for which the CRI is in the range between 85 and 90. The second area around the central area in FIG. 3A represents the area for which the CRI is in the range between 80 and 85, and so on. It can be seen that given the relatively broad FWHM (above 50 nm) of the red-emitting luminescent material 8 in combination with a peak wavelength of 610 nm (in the preferred range from 600 to 615 nm), values of the color-rendering index above CRI≧90 can be realized with a combination of only three colors in a relatively large wavelength range.

FIG. 3B shows the color-rendering index for a color-mixing lighting system according to an embodiment of the invention comprising a blue and a green LED 6, 7 in combination with a red-emitting luminescent material 8 as a function of the blue and green LED peak wavelength for a color temperature of 5000 K.

In the example of FIG. 3B, a red-emitting luminescent material 8 is employed with a wavelength peak of 610 nm and with a FWHM of 83 nm. Along the y-axis of FIG. 3B, the peak wavelength λ_{p, B} (expressed in nm) of the blue LED 6 with a typical FWHM of 23 nm is depicted with the peak wavelengths varying between 447 nm and 482 nm. Along the x-axis of FIG. 3B the peak wavelength λ_{p, G} (expressed in nm) of the green LED 7 with a typical FWHM of 35 nm is depicted with the peak wavelengths varying between 512 nm and 557 nm. The different areas depicted in FIG. 3B show the areas with a certain value of the color-rendering index (CRI). In particular, the central area in FIG. 3B represents the area for which the CRI is in the range between 90 and 95. The first area around the central area in FIG. 3B represents the area for which the CRI is in the range between 85 and 90. The second area around the central area in FIG. 3B represents the area for which the CRI is in the range between 80 and 85, and so on. It can be seen that given the relatively broad FWHM (above 50 nm) of the red-emitting luminescent material 8 in combination with a peak wavelength of 610 nm (in the preferred range from 600 to 615 nm), values of the color-rendering index above CRI≧90 can be realized with a combination of only three colors in a relatively large wavelength range.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A color-mixing lighting system (1) comprising:
a light-emitting diode (6, 7) emitting first visible light having a first peak wavelength in a first spectral range,
a fluorescent material (8, 9) converting a portion of the first visible light into second visible light having a second peak wavelength in a second spectral range,
the second visible light having a full width at half maximum (FWHM) of at least 50 nm.

2. A color-mixing lighting system as claimed in claim 1, characterized in that the second visible light is red light, the second peak wavelength being in the range from 590 to 630 nm.

3. A color-mixing lighting system as claimed in claim 2, characterized in that the second peak wavelength is in the range from 600 to 615 nm.

4. A color-mixing lighting system as claimed in claim 1, characterized in that the first visible light-emitting diode (6) emits blue light, the first peak wavelength being in the range from 445 to 470 nm and the full-width at half maximum (FWHM) being in the range from 15 to 30 nm.

5. A color-mixing lighting system as claimed in claim 1, characterized in that the lighting system comprises a further light-emitting diode (7) for emitting third visible light having a third peak wavelength in a third spectral range.

6. A color-mixing lighting system as claimed in claim 4, characterized in that the further light-emitting diode (7) emits green light, the third peak wavelength being in the range from 510 to 550 nm and the full width at half maximum (FWHM) being in the range from 25 to 45 nm.

7. A color-mixing lighting system as claimed in claim 1, characterized in that the fluorescent material (8) converts blue light into red light, the fluorescent material being selected from the group formed by SrS:Eu, Sr₂Si₅N₈:Eu, CaS:Eu, Ca₂Si₅N₈:Eu,
(Sr₁₋ₓCaₓ)S:Eu and (Sr₁₋ₓCaₓ)₂Si₅N₈:Eu and (x=0.0-1.0).

8. A color-mixing lighting system as claimed in claim 1, characterized in that the lighting system comprises a further fluorescent material (9) converting a portion of the first visible light into third visible light having a third peak wavelength in a third spectral range with the third peak wavelength in the range from 510 to 550 nm and a FWHM of at least 40 nm.

9. A color-mixing lighting system as claimed in claim 7, characterized in that the further fluorescent material (9) converts blue light into green light, the fluorescent material being selected from the group formed by (Ba₁₋ₓSrₓ)₂SiO₄:Eu (x=0-1, preferably x=0.5), SrGa₂S₄:Eu, Lu₃Al₅O₁₂:Ce and SrSi₂N₂O₂:Eu.
